(19) United States
(12) Patent Application Publication
(10) Pub. No.: US 2025/0131842 A1
(43) Pub. Date: Apr. 24, 2025

(54) INTERACTIVE PLAY MAT DEVICE

(71) Applicant: Denise Law, Dayton, OH (US)

(72) Inventor: Denise Law, Dayton, OH (US)

(21) Appl. No.: 18/382,430

(22) Filed: Oct. 20, 2023

(51) Int. Cl. G09B 5/06; A47D 13/00

(52) U.S. Cl. CPC G09B 5/062; A47D 13/00

(57) ABSTRACT

An interactive play mat device for children includes a front surface, a rear surface, and a peripheral surface extending therebetween thereby defining an interior space. Decorative indicia are printed on the front surface. A central processing unit is positioned in the interior space that includes a memory unit having a plurality of recordings stored thereon. A sound emitter is operationally coupled to the central processing unit to selectively play the plurality of recordings. Each of a plurality of pressure sensors is positioned within the interior space beneath a respective one of the decorative indicia to detect a pressure being applied to the respective one of the decorative indicia. The central processing unit plays at least one of the recordings when the pressure is detected. A plurality of light emitters is positioned within the interior space. The central processing unit illuminates the plurality of light emitters when the pressure is detected.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to floor mats and more particularly pertains to a new floor mat for teaching and entertaining children during playtime.

### (2) Description of Related Art Including Information Disclosed Under 37 CFR 1.97 and 1.98

The prior art relates to floor mats. The prior art discloses flexible floor mats for children to use during playtime. Some of these mats have integrated lights and graphics to better entertain the children. Other mats incorporate educational stimuli, such as letters printed on the surface of the mats to help teach the children language skills. However, there is a need in the art for a play mat which teaches various lessons to children using imagery, lights, and audio content using an incorporated pressure sensing system to activate the lights and audio content. There is also a need for a play mat that can be used to impart religious teachings to the children in a fun and engaging way.

### BRIEF SUMMARY OF THE INVENTION

An embodiment of the disclosure meets the needs presented above by generally comprising a mat having a front surface, a rear surface, and a peripheral surface extending therebetween thereby defining an interior space. A plurality of decorative indicium is printed on the front surface. A power source is positioned in the interior space. A central processing unit is positioned in the interior space and is operationally coupled to the power source. The central processing unit may include a memory unit having a plurality of recordings stored thereon. A sound emitter is operationally coupled to the central processing unit to play the plurality of recordings. A plurality of pressure sensors is positioned in the interior space. Each of the plurality of pressure sensors is operationally coupled with the central processing unit and is positioned beneath a respective one of the plurality of decorative indicium. Each of the plurality of pressure sensors is configured to detect a pressure being applied to the respective one of the plurality of decorative indicum. The central processing unit is configured to play at least one of the plurality of recordings audibly with the speaker when at least one of the plurality of pressure sensors detects the pressure. A plurality of light emitters is positioned within the interior space. Each of the plurality of light emitters is electronically coupled to the central processing unit whereby the central processing unit is configured to illuminate a one of the plurality of light emitters when at least one of the plurality of pressure sensors detects the pressure being applied to the respective one of the plurality of decorative indicium.

There has thus been outlined, rather broadly, the more important features of the disclosure in order that the detailed description thereof that follows may be better understood, and in order that the present contribution to the art may be better appreciated. There are additional features of the disclosure that will be described hereinafter, and which will form the subject matter of the claims appended hereto.

The objects of the disclosure, along with the various features of novelty which characterize the disclosure, are pointed out with particularity in the claims annexed to and forming a part of this disclosure.

### ) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of an interactive play mat device according to an embodiment of the disclosure.

FIG. 2 is a rear isometric view of an embodiment of the disclosure.

FIG. 3 is a side view of an embodiment of the disclosure.

FIG. 4 is a cross-sectional view of an embodiment of the disclosure.

FIG. 5 is a cross-sectional view of an embodiment of the disclosure.

FIG. 6 is a side in-use view of an embodiment of the disclosure.

FIG. 7 is a top in-use view of an embodiment of the disclosure.

### DETAILED DESCRIPTION OF THE INVENTION

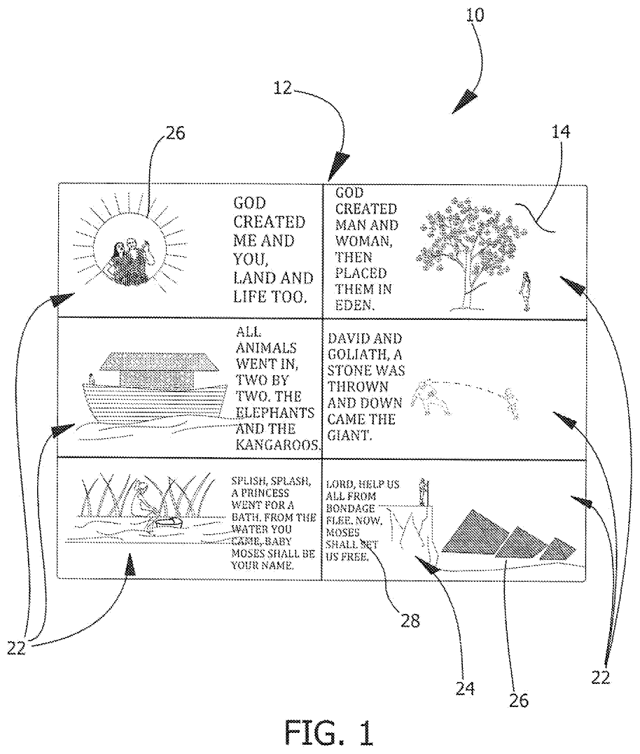

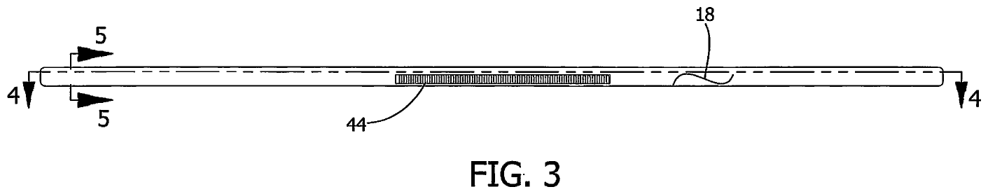

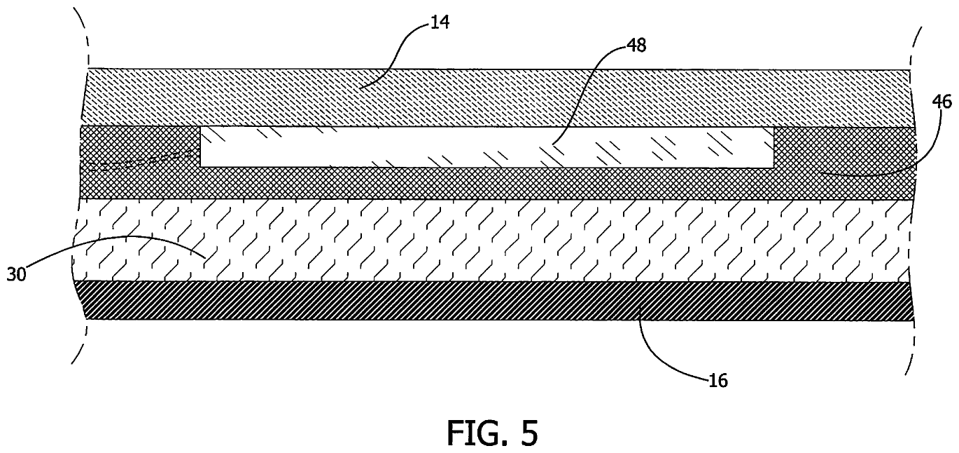

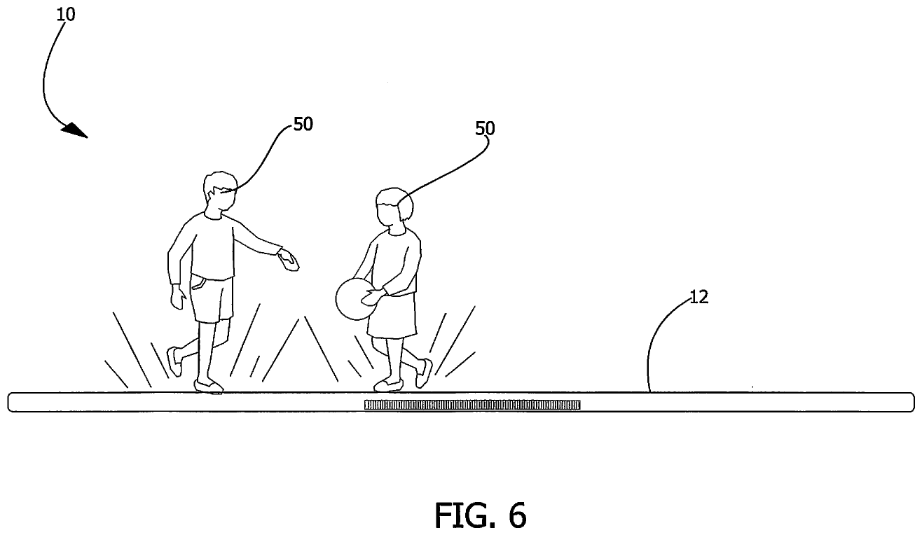

With reference now to the drawings, and in particular to FIGS. 1 through 7 thereof, a new floor mat embodying the principles and concepts of an embodiment of the disclosure and generally designated by the reference numeral 10 will be described.

As best illustrated in FIGS. 1 through 7, the interactive play mat device 10 generally comprises a mat 12 having a front surface 14, a rear surface 16, and a peripheral surface 18 extending therebetween thereby defining an interior space 20. The mat 12 is generally a play mat, which may be positioned on a floor surface for a user 50 to walk or move over. A resiliently compressible cushion material 30 may be positioned within the interior space 20 thereby making the mat 12 safer and more comfortable for the user 50 to walk or move over.

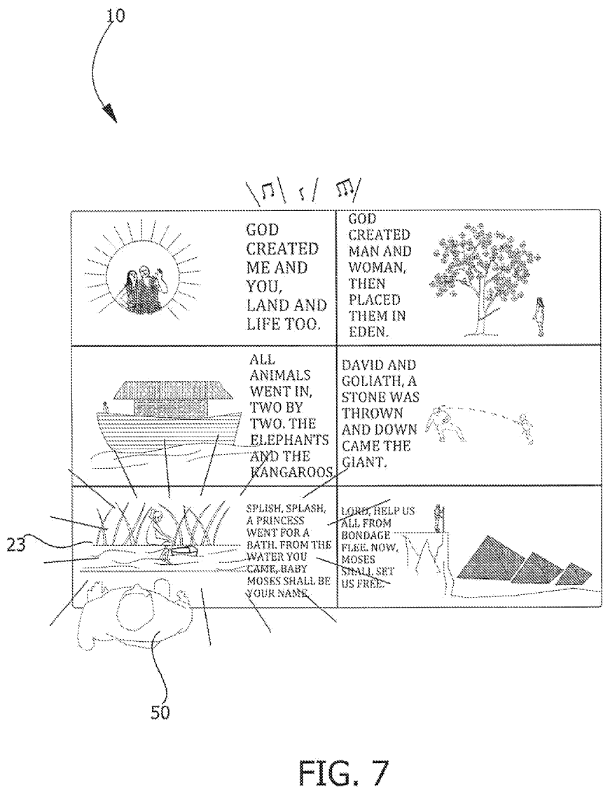

A plurality of decorative indicium 22 is printed on the front surface 14. Each of the plurality of decorative indicium 22 represent a respective lesson. For example, the front surface 14 may depict six decorative indicum, each of which respectively represents a different lesson for the user 50. In the example provided in FIGS. 1 and 7, the respective lessons each have a religious theme. More specifically, FIGS. 1 and 7 show the plurality of decorative indicium 22 representing six stories from the Judeo-Christian religious tradition. With this embodiment, the mat 12 can be used to educate the user 50 about each respective lesson within the religious theme. Each of the plurality of decorative indicium 22 may include a picture 26 depicting the respective lesson of each of the plurality of decorative indicium 22 and a quote 28 describing the picture 26.

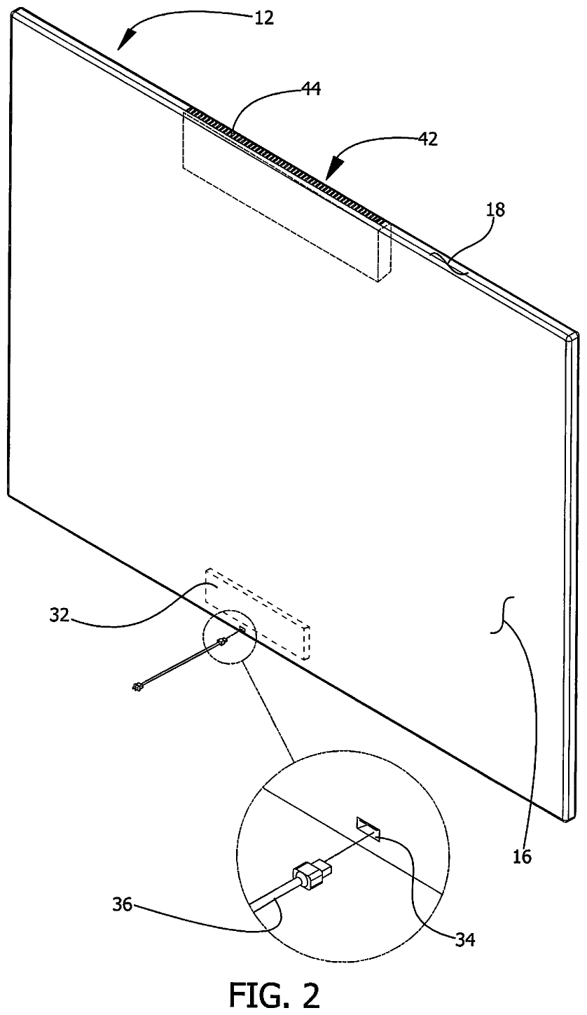

A power source 32 is positioned in the interior space 20. The power source 32 may be a rechargeable battery. A charging port 34 may be positioned inset to one of the surfaces of the mat 12. For example, the charging port 34 may be positioned inset to the rear surface 16 and may be exposed on the rear surface 16 as shown in FIG. 2. In alternative embodiments, the charging port 34 may be inset to and exposed on either the front surface 14 or the peripheral surface 18. The charging port 34 is operationally coupled to the power source 32, for example being electronically coupled to the power source 32 through a hardwired connection. The charging port 34 is configured to receive a charging cord 36.

A central processing unit 38 is positioned in the interior space 20. The central processing unit 38 is operationally or electronically coupled to the power source 32. The central processing unit 38 generally includes a memory unit 40 having a plurality of recordings stored thereon. Each of the plurality of recordings may relate to the respective lesson for each of the plurality of decorative indicium 22. For example, in the embodiment shown in FIG. 1, the decorative indicium on the top left-hand side of the mat 12 depicts the creation story from the Judeo-Christian Old Testament. Specifically, the picture 26 shows the sun encircling Adam and Eve, two characters from the creation story. The quote 28 states “God created me and you, land and life too,” which is related to the creation story being depicted. In this embodiment, one of the plurality of recordings may relate to and further explain this creation story, while others of the plurality of recordings may relate to and further explain the other respective lessons 24 associated with each of the other ones of the plurality of decorative indicium 22.

A sound emitter 42 is operationally or electronically coupled to the central processing unit 38 to play the plurality of recordings. The sound emitter 42 may include a speaker 44 that is inset to the peripheral surface 18 and that is exposed on the peripheral surface 18, as shown in FIGS. 2-4. In other embodiments, the speaker 44 may be inset to and exposed on the front surface 14. The speaker 44 could also be inset to and exposed on the rear surface 16, but that could result in muffled playback of the plurality of recordings when the mat 12 is positioned on a ground or floor surface. The central processing unit 38 is configured to play at least one of the plurality of recordings audibly with the speaker 44.

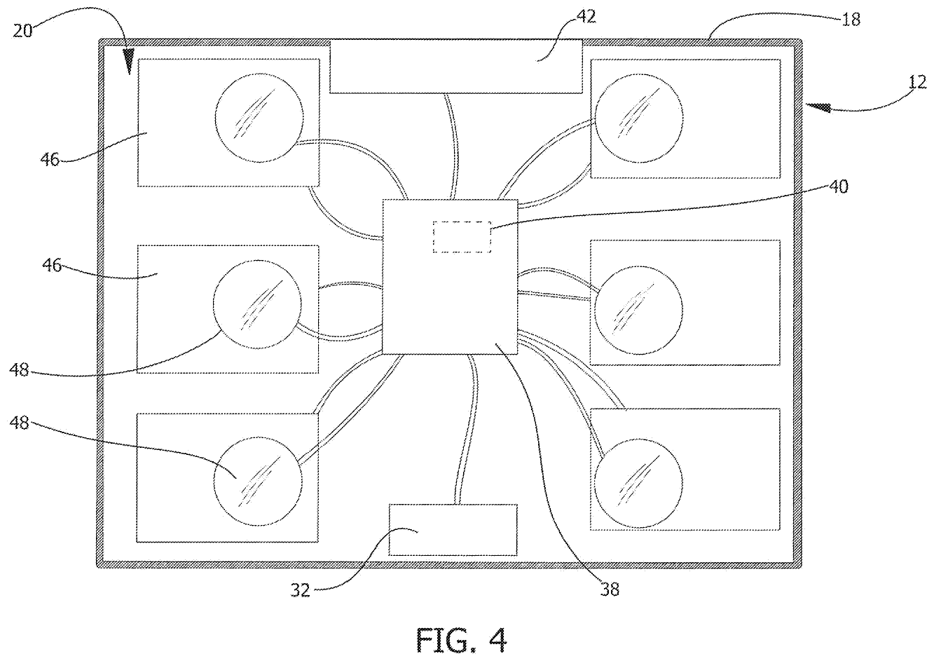

A plurality of pressure sensors 46 is positioned in the interior space. Each of the plurality of pressure sensors 46 is operationally or electronically coupled to the central processing unit 38. Each of the plurality of pressure sensors 46 is generally positioned beneath a respective one of the plurality of decorative indicium 23. For example, when embodiments having six of the plurality of decorative indicium 22 printed on the front surface 14 may include six of the plurality of pressure sensors 46, as shown in FIG. 4. Each of the plurality of pressure sensors 46 is configured to detect a pressure being applied to the respective one of the plurality of decorative indicum 23. The central processing unit 38 is configured to play at least one of the plurality of recordings when at least one of the plurality of pressure sensors 46 detects the pressure. For example, as shown in FIG. 7, the central processing unit 38 may play the recording associated with the bottom left one of the plurality of decorative indicium 23 when the user 50 is standing on top of that respective one of the plurality of decorative indicium 23.

A plurality of light emitters 48 is also positioned within the interior space 20. Each of the plurality of light emitters 48 is operationally or electronically coupled to the central processing unit 38 whereby the central processing unit 38 is configured to illuminate a one of the plurality of light emitters when at least one of the plurality of pressure sensors detects the pressure being applied to the respective one of the plurality of decorative indicium 23. The one of the plurality of light emitters being illuminated is generally positioned beneath the respective one of the plurality of decorative indicium 23. In some embodiments, the front surface 14 may be transparent whereby the light emitted by the one of the plurality of light emitters is visible when the central processing unit 38 illuminates the one of the plurality of light emitters.

In use, a user 50 can stand on top of the respective one of the plurality of decorative indicium 23 representing the respective lesson 24 about which the user 50 wants to learn. The user 50 can view the picture 26 and read the quote 28 associated with the respective lesson 24 while listening to the associated recording being played by the central processing unit 38 through the sound emitter 42. When the one of the plurality of pressure sensors 46 positioned beneath the respective one of the plurality of decorative indicium 23 detects the pressure being applied to the respective one of the plurality of decorative indicium 23, the central processing unit 38 can also illuminate the respective light emitter positioned beneath the respective one of the plurality of decorative indicium 22. By combining pictures, quotes, lights, and recordings, the mat 12 can be used to impart significant amounts of educational information about each respective lesson 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. An interactive play mat device comprising:
a mat having a front surface, a rear surface, and a peripheral surface extending therebetween thereby defining an interior space, the front surface being continuous within the bounds of the peripheral surface wherein the front surface covers an entirety of a front boundary of the interior space;
a plurality of decorative indicium being printed on the front surface;
a power source being positioned in the interior space;
a central processing unit being positioned in the interior space, the central processing unit being operationally coupled to the power source, the central processing unit including:
a memory unit having a plurality of recordings stored thereon;
a sound emitter being operationally coupled to the central processing unit to play the plurality of recordings;
a plurality of pressure sensors being positioned in the interior space, each of the plurality of pressure sensors being operationally coupled to the central processing unit, each of the plurality of pressure sensors being positioned beneath a respective one of the plurality of decorative indicium, each of the plurality of pressure sensors being configured to detect a pressure being applied to the respective one of the plurality of decorative indicum, the central processing unit being configured to play at least one of the plurality of recordings when at least one of the plurality of pressure sensors detects the pressure; and
a plurality of light emitters being positioned within the interior space, each of the plurality of light emitters being operationally coupled to the central processing unit whereby the central processing unit is configured to illuminate a one of the plurality of light emitters when at least one of the plurality of pressure sensors detects the pressure being applied to the respective one of the plurality of decorative indicium.

2. The interactive play mat device of claim 1, further comprising a resiliently compressible cushion material being positioned in the interior space.

3. The interactive play mat device of claim 1, wherein each of the plurality of decorative indicium represent a respective lesson.

4. The interactive play mat device of claim 3, the respective lesson of each of the decorative indicium further comprising a religious theme.

5. The interactive play mat device of claim 3, wherein each of the plurality of recordings relates to the respective lesson of each of the plurality of decorative indicium.

6. The interactive play mat device of claim 3, each of the plurality of decorative indicium further comprising:
a picture depicting the lesson the respective lesson of each of the plurality of decorative indicium; and
a quote describing the picture.

7. The interactive play mat device of claim 1, further comprising a charging port being positioned inset to the rear surface and being exposed on the rear surface, the charging port being operationally coupled to the power source, the charging port being configured to receive a charging cord.

8. The interactive play mat device of claim 1, further comprising a charging port being positioned inset to the peripheral surface and being exposed on the peripheral surface, the charging port being operationally coupled to the power source, the charging port being configured to receive a charging cord.

9. The interactive play mat device of claim 1, further comprising a charging port being positioned inset to the front surface and being exposed on the front surface, the charging port being operationally coupled to the power source, the charging port being configured to receive a charging cord.

10. The interactive play mat device of claim 1, the sound emitter further comprising:
a speaker being inset to the peripheral surface and being exposed on the peripheral surface; and
the central processing unit being configured to play at least one of the plurality of recordings audibly with the speaker.

11. The interactive play mat device of claim 1, wherein the front surface is transparent whereby the light emitted by the one of the plurality of light emitters is visible when the central processing unit illuminates the one of the plurality of light emitters.

12. The interactive play mat device of claim 1, wherein the one of the plurality of light emitters is positioned beneath the respective one of the plurality of decorative indicium.

13. The interactive play mat device of claim 1, wherein the power source is a rechargeable battery.

14. An interactive play mat device comprising:
a mat having a front surface, a rear surface, and a peripheral surface extending therebetween thereby defining an interior space, the front surface being continuous within the bounds of the peripheral surface wherein the front surface covers an entirety of a front boundary of the interior space;
a plurality of decorative indicium being printed on the front surface, each of the plurality of decorative indicium representing a respective lesson, each of the plurality of decorative indicium including:
a picture depicting the respective lesson of each of the plurality of decorative indicium;
a quote describing the picture;
a resiliently compressible cushion material being positioned in the interior space;
a power source being positioned in the interior space, the power source being a rechargeable battery;
a charging port being positioned inset to the rear surface and being exposed on the rear surface, the charging port being electronically coupled to the power source, the charging port being configured to receive a charging cord;
a central processing unit being positioned in the interior space, the central processing unit being electronically coupled to the power source, the central processing unit including:
a memory unit having a plurality of recordings stored thereon, each of the plurality of recordings relating to the lesson;
a sound emitter being electronically coupled to the central processing unit to selectively play the plurality of recordings, the sound emitter including:
a speaker being inset to the peripheral surface and being exposed on the peripheral surface;
the central processing unit being configured to play at least one of the plurality of recordings audibly with the speaker;
a plurality of pressure sensors being positioned in the interior space, each of the plurality of pressure sensors being electronically coupled to the central processing unit, each of the plurality of pressure sensors being positioned beneath a respective one of the plurality of decorative indicium, each of the plurality of pressure sensors being configured to detect a pressure being applied to the respective one of the plurality of decorative indicum, the central processing unit being configured to play at least one of the plurality of recordings audibly with the speaker when at least one of the plurality of pressure sensors detects the pressure;
a plurality of light emitters being positioned within the interior space, each of the plurality of light emitters being electronically coupled to the central processing unit whereby the central processing unit is configured to illuminate a one of the plurality of light emitters when at least one of the plurality of pressure sensors detects the pressure being applied to the respective one of the plurality of decorative indicium, the one of the plurality of light emitters being positioned beneath the respective one of the plurality of decorative indicium; and
the front surface being transparent whereby the light emitted by the one of the plurality of light emitters is visible when the central processing unit illuminates the one of the plurality of light emitters.
